(19) United States
(12) Patent Application Publication
(10) Pub. No.: US 2002/0073582 A1
(43) Pub. Date: Jun. 20, 2002

(54) Process control method

(75) Inventors: Takao Yoshioka, Osaka (JP); Tetsuya Watanabe, Osaka (JP)

Correspondence Address: Jordan and Hamburg, 122 East 42nd Street, New York, NY, 10168, US

(73) Assignee: Toyo Tire & Rubber Co., Ltd.

(21) Appl. No.: 09/742,154

(22) Filed: Dec. 20, 2000

(51) Int. Cl. G09F 1/00

(52) U.S. Cl. 40/124.01

(57) ABSTRACT

A pinholed board 22, as provided with a plurality of pinholes 30 determined according to a material number, is attached to a rubber container 24 containing a rubber material, and this rubber container 24 is transferred to a rubber reserving section 16. At a molding step 18, there is displayed a condition table 36 according to working conditions. The condition table 36 is provided with a attaching base 42 of the board 22, and the attaching base 42 is provided with a number of projections 46 determined according to the number of the rubber material to be worked, so that the board 22 having the same material number can be exclusively attached. The molding work is not started before the rubber container 24 is transferred from the rubber reserving section 16 to the molding step 18 and before the board 22 attached to the rubber container 24 is attached to the attaching base 42 of the condition table 36. Thus, the operator of the working step in a factory can be prevented reliably from working the material of a mistaken kind.

### BACKGROUND OF THE INVENTION

The present invention relates to a process control method at a factory. More specifically, the invention relates to a process control method for preventing an operator reliably at a working step of working a material from working a material of a different kind erroneously.

To a working step at a factory, generally, there is assigned an operator for taking care of each working apparatus to operate this apparatus on the basis of a condition table specified for each product. In this condition table, there are instructed the material number of a material to be worked, conditions for operating the working apparatus and so on, according to which the operator fetches the material from a material reserving section to work the fetched material in accordance with the condition table.

In the prior art, the operator of this working step fetches the material from the material reserving section by visually collating the material number indicated in the condition table and the numbers of materials reserved in the material reserving section. In the visual collation, however, the operator may make a mistake to fetch a material different from the instructed one. In this case, the mistaken material is worked to consume not only the material but the time period uselessly. Especially in recent years, the products are diversified in varieties by the many kinds of products so that such mistakes are easily caused.

Merely by the visual collations of the operator in the prior art, on the other hand, even the general administrator may be troubled for walking around for finding out that the operator for each step makes a mistake in the material.

### SUMMARY OF THE INVENTION

The invention has been conceived in view of the discussion thus far made and has an object to provide a process control method capable of preventing an operator of a working step reliably from misuse a material different from that instructed by a condition table.

According to the invention, there is provided a process control method comprising the steps (1) to (3):

(1) attaching a board to a material in accordance with a number allocated to said material, and transferring the material to a material reserving section,

wherein the board indicates the material number on its surface and includes an engagement portion determined according to the material number;

(2) displaying a condition table according to a working condition at a step of working the material,

wherein the condition table includes an attaching base for the board, and wherein the attaching base has an engagement portion determined according to the material number of the material to be worked and made engageable with only the engagement portion of the board of the same material number; and

(3) transferring the material from the material reserving section to the working step but does not start the working before the board attached to the material is attached to the attaching base of the condition table.

According to this method of the invention, the working is not started before the board attached to the material is attached to the attaching base of the condition table, and what can be attached to the attaching base is the only board of the same material number. It is, therefore, possible to prevent the operator reliably from working a different material erroneously. Even if a material different from that in the condition table is erroneously carried by the operator from the material reserving section, the board attached to the material cannot be attached to the attaching base of the condition table because it bears the different material number. Therefore, the operator can reliably find out that the carried material is mistaken.

According to the method of the invention, on the other hand, the working is performed after the board indicating the material number is attached to the condition table. It is, therefore, possible to confirm not only the material number of the material being worked but also that the different material is not used, at a glance from the outside. Thus, the administrator can easily find the mistake of the material being worked, while going round the factory.

In the process control method, it is preferable that the engagement portion of the board has a plurality of holes arranged according to the material number indicated on its surface, and that the engagement portion of the attaching base has a plurality of projections determined according to the material number of the material to be worked and disposed at positions corresponding to a plurality of holes of the board so that the board of the same material number may be exclusively attached to the attaching base. However, the relation between these two may be reversed to provide the plurality of projections on the board and the plurality of holes in the attaching base.

In the process control method, it is arbitrary that the working is not started before the operator of the working step fetches the material indicated in the condition table from the material reserving section and attaches the board of the fetched material to the attaching base of the condition table. In this case, it is preferable that the fetch board describing the material number of the material to be worked is displayed together with the condition table at the working step so that the operator of the working step fetches the material from the material reserving section while carrying the fetch board.

In the process control method, on the other hand, it is arbitrary that the step of manufacturing the material is assigned to a first factory whereas the working step is assigned to a second factory, so that the board is not attached before the material transferred from the first factory is received by a receiving section of the second factory and is inspected. The step of manufacturing the material may be disposed at the same factory as that of the working step.

In the process control method, the board may be colored on its surface in a predetermined color according to the material number. In this case, the kind of the material can be discriminated with the color of the board surface to facilitate the material discrimination.

In the process control method, the board may be attached to a container containing the material.

In the process control method of the invention, the material is not especially limited, but the invention is generally effective for the material the kind of which can not be easily discriminated from the outside. For example, the material is exemplified by a molding material such as a rubber or a resin, a fabric such as a woven fabric, a knitted goods or a nonwoven fabric, or a part such as a bolt or a nut. Here, when the material is the molding material, the working step is a molding step. When the material is the fabric, the working step is a fabric-working step such as a dyeing or coating step. When the material is the part, moreover, the working step is usually an assembly step of assembling a plurality of parts.

### BRIEF DESCRIPTION OF THE DRAWINGS

FIG. 1 is a schematic diagram showing a flow of a process control method according to one embodiment of the invention;

FIG. 2 is a perspective view of a rubber box in the embodiment;

FIG. 3 is an enlarged perspective view showing a portion of a working apparatus in the embodiment;

FIGS. 4A to 4C are top plan views of a pinholed board in the embodiment; and

FIGS. 5A and 5B are perspective views of a table attaching portion of the working apparatus in the embodiment.

### DETAILED DESCRIPTION OF THE PREFERRED EMBODIMENT

A process control method according to one embodiment of the invention will be described with reference to the accompanying drawings. This embodiment will be described on the case in which there is exemplified a process control method for vulcanizing and molding a rubber material.

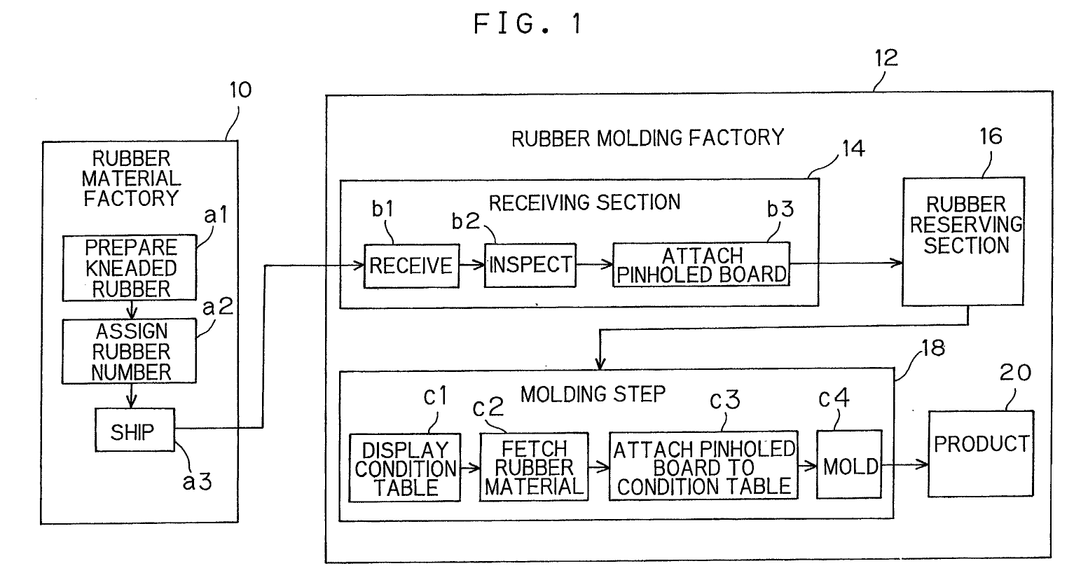

As shown in FIG. 1, the material or rubber is prepared in a rubber material factory 10. In this rubber material factory 10: kneaded rubber is prepared at Step a1 at a predetermined blending ratio; a material number or rubber number is assigned at Step a2 to the prepared rubber of each blend; and the numbered rubber is shipped at Step a3 to a rubber molding factory 12.

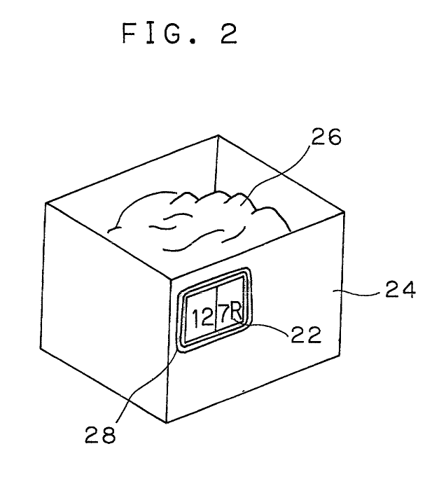

In this rubber molding factory 12, the kneaded rubber material is received (at Step b1) by a receiving section 14 such as the production control section. At this receiving section 14, a skilled expert inspector inspects the kneaded rubber (at Step b2), and attaches a pinholed board 22 according to the rubber number, to a rubber container 24 (at Step b3), as shown in FIG. 2, for an accepted product satisfying the arrival standards.

Here, the rubber container 24 is a box-shaped container containing the materials or kneaded rubber strings 26, and the pinholed board 22 is detachably attached to an attaching portion 28 disposed on the side face of the rubber container 24.

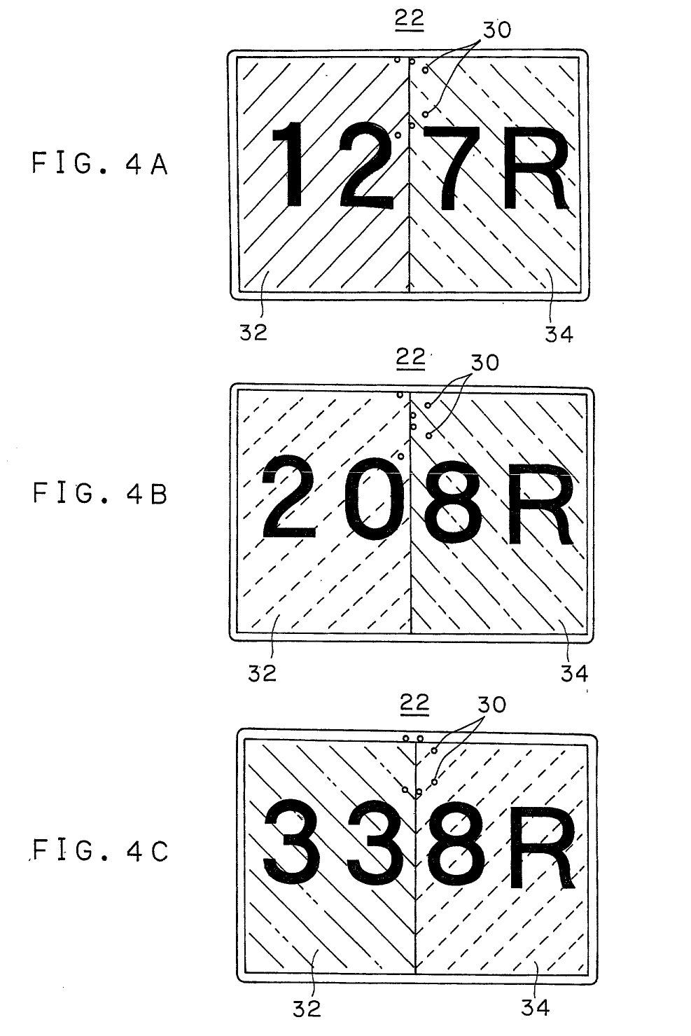

The pinholed board 22 indicates the rubber number (e.g., “127R”) on its surface and is provided with a plurality of pinholes 30 arranged according to the rubber number. In this embodiment, six pinholes 30 are so formed in the central upper portion of the board 22 that they take different positional relations according to the rubber number, as shown in FIGS. 4A to 4C.

On the other hand, the pinholed board 22 is colored on its surface in two left and right colors according to the rubber number. For example: the board 22 shown in FIG. 4A is colored in red on the lefthand half 32 and yellow on the righthand half 34; the board 22 shown in FIG. 4B is colored in white on the lefthand half 32 and pink on the righthand half 34; and the board 22 shown in FIG. 4C is colored in red on the lefthand half 32 and green on the righthand half 34.

As shown in FIG. 1, the rubber container 24 thus having the pinholed board 22 attached thereto is transferred to a rubber reserving section 16, in which it is stored till it is transferred to a next step or a molding step 18. Here, the rubber reserving section 16 is not especially limited if it has such a space as can reserve a predetermined number of rubber containers 24 containing the kneaded rubber 26.

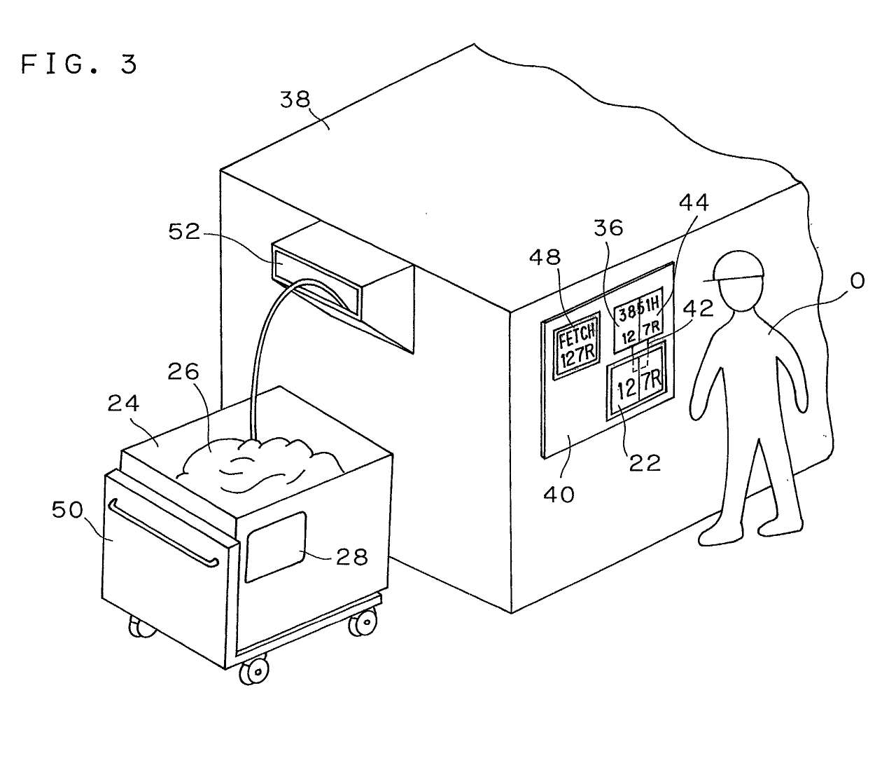

At the molding step 18, a condition table according to a product is displayed first of all (at Step cl). The condition table, as indicated at 36 in FIG. 3, is so detachably attached to a table attaching portion 40 disposed on the side face of a vulcanizing/molding apparatus 38 as can be viewed at a glance from the outside. An operator O attaches the condition table 36 at first to the table attaching portion 40 before the molding step is started.

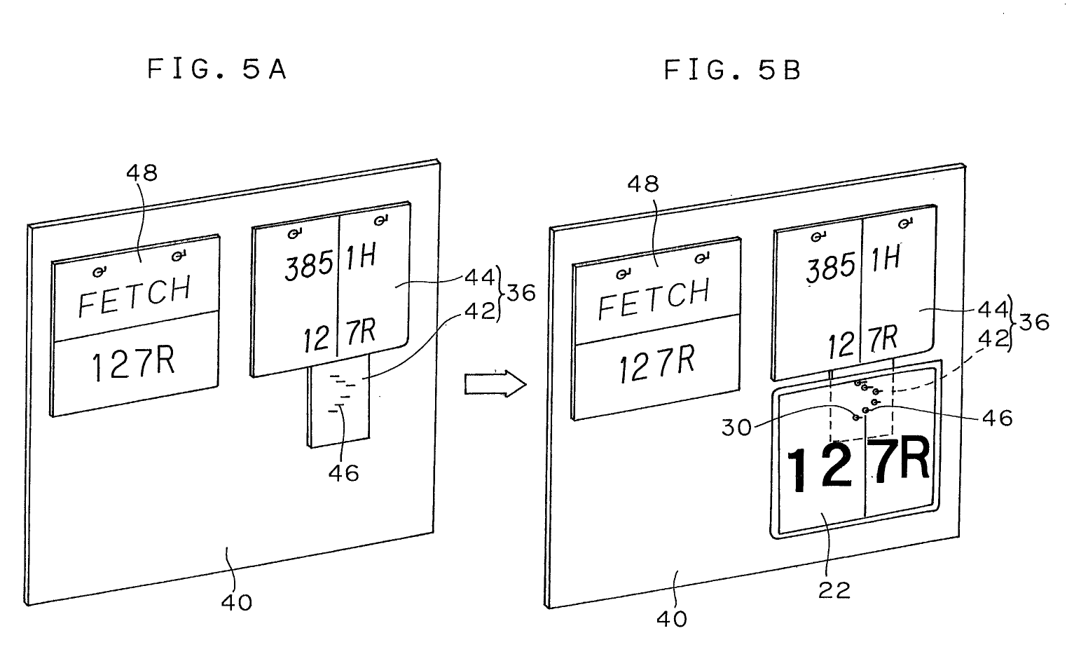

Here, the condition table 36 is constructed, as shown in FIGS. 5A and 5B, to include: a number indicating portion 44 indicating a product number (e.g., “3851H”) and the rubber number (e.g., “127R”) juxtaposed vertically; and an attaching base 42 for the pinholed board 22. This attaching base 42 is protruded from the lower side of the number indicating portion 44. The attaching base 42 is provided with a plurality of needle-shaped projections 46 which are determined according to the rubber number of the rubber to be worked. These projections 46 are arranged at positions corresponding one-by-one to the pinholes 30 of the pinholed board 22 so that the pinholed board 22 of the same rubber number may be exclusively attached to the attaching base 42. On the other hand, the number indicating portion 44 is also colored on its surface in such two left and right colors according to the rubber number as are set as those of the pinholed board 22.

To the table attaching portion 40 of the vulcanizing/molding apparatus 38, as shown in FIG. 5A, there is detachably attached another fetch board 48 in which the rubber number (e.g., “127R”) of the kneaded rubber to be worked is indicated.

The operator O carries the fetch board 48 and fetches the rubber container 24 from the rubber reserving section 16 (at Step c2). In this rubber reserving section 16, more specifically, the operator O searches the rubber container 24, to which the pinholed board 22 bearing the number identical to the rubber number indicated by the fetch board 48 is attached, and carries back that rubber container 24 on a truck 50 to the molding apparatus 38.

As shown in FIGS. 3 and 5B, the operator O then attaches the carried fetch board 48 to the table attaching portion 40 of the molding apparatus 38, and attaches the pinholed board 22, as attached to the fetched rubber container 24, to the attaching base 42 of the condition table 36 (at Step c3).

At this time, if the fetched rubber container 24 bears a rubber number different from that assigned by the condition table 36, its pinholed board 22 has the pinholes 30 different from the projections 46 of the attaching base 42 so that it cannot be attached to the attaching base 42. Therefore, the operator O finds out that the carried rubber container 24 is mistaken, and carries again the fetch board 48 to fetch the rubber container 24 from the rubber reserving section 16.

After this, the operator O sets the rubber 26 of the rubber container 24 in the molding apparatus 38 and starts its vulcanizing/molding work (at Step c4). As shown in FIG. 3, more specifically, the rubber string 26 contained in the rubber container 24 is inserted from its one end portion into an input port 52 of the molding apparatus 38 and set in the molding apparatus 38. Then, the operator O operates the molding apparatus 38 under predetermined vulcanizing/molding conditions. As a result, the molded rubber or product 20 is manufactured, as shown in FIG. 1.

According to the embodiment, as has been described hereinbefore, the molding work is not started before the pinholed board 22 attached to the rubber container 24 is attached to the attaching base 42 of the condition table 36. In addition, what can be attached to the attaching base 42 is the pinholed board 22 of the same number. Therefore, it is possible to prevent the operator O by the reliable, simple and low-cost method from working a different rubber container 24 erroneously.

The operator O for this molding step 18 is generally assigned a primary task to operate the molding apparatus 38 and a secondary task to collate the rubber number. It is, therefore, difficult for the operator O to eliminate the collation mistake of the rubber number by 100% at the time of fetching the rubber container 24. According to the embodiment, on the contrary, even if the operator O makes the collation mistake, the operator O cannot attach the pinholed board 22 to the condition table 36 of the molding apparatus 38 so that the molding work using a mistaken rubber material can be prevented by 100%.

Here, if the pinholed board 22 is erroneously attached (at Step b3) to the rubber container 24, it is impossible to prevent the mistaken rubber material by 100% from being molded. However, the attachment of the pinholed board 22 at Step b3 is performed by the skilled expert inspector belonging to the process control section. Therefore, the possibility for the mistake is far lower than that to be made by the operator O of the molding step 18 so that the object of the invention is sufficiently achieved.

According to the method of the embodiment, the molding work is started after the pinholed board 22 indicating the rubber number is attached to the condition table 36 so that the administrator can confirm the rubber number of the rubber being used in the work, at a glance from the outside. On the other hand, the administrator is enabled to confirm whether or not the correct rubber material is worked, merely by confirming whether or not the pinholed board 22 is tacked. From the description thus far made, the administrator easily discovers the mistake of the rubber material at the molding step 18 while going round the factory.

What is claimed is:

1. A process control method comprising the steps (1) to (3):
(1) attaching a board to a material in accordance with a number allocated to said material, and transferring said material to a material reserving section,
wherein said board indicates the material number on its surface and includes an engagement portion determined according to the material number;
(2) displaying a condition table according to a working condition at a step of working said material,
wherein said condition table includes an attaching base for said board, and wherein said attaching base has an engagement portion determined according to the material number of the material to be worked and made engageable with only the engagement portion of the board of the same material number; and
(3) transferring the material from the material reserving section to the working step but does not start the working before the board attached to said material is attached to the attaching base of the condition table.

2. A process control method according to claim 1,
wherein the engagement portion of said board has a plurality of holes arranged according to the material number indicated on its surface, and
wherein the engagement portion of said attaching base has a plurality of projections determined according to the material number of the material to be worked and disposed at positions corresponding to a plurality of holes of said board so that the board of the same material number may be exclusively attached to the attaching base.

3. A process control method according to claim 1,
wherein the working is not started before the operator of the working step fetches the material indicated in the condition table from the material reserving section and attaches the board of the fetched material to the attaching base of the condition table.

4. A process control method according to claim 3,
wherein the fetch board describing the material number of the material to be worked is displayed together with said condition table at the working step so that the operator of the working step fetches the material from the material reserving section while carrying said fetch board.

5. A process control method according to claim 1,
wherein the step of manufacturing said material is assigned to a first factory whereas said working step is assigned to a second factory, so that said board is not attached before the material transferred from the first factory is received by a receiving section of the second factory and is inspected.

6. A process control method according to claim 1,
wherein said board is colored on its surface in a predetermined color according to the material number.

7. A process control method according to claim 1,
wherein said board is attached to a container containing the material.

8. A process control method according to claim 1,
wherein said material is a molding material such as a rubber or a resin, a fabric such as a woven fabric, a knitted goods or a nonwoven fabric, or a part such as a bolt or a nut.
